(19) United States
(12) Patent Application Publication
(10) Pub. No.: US 2004/0058216 A1
(43) Pub. Date: Mar. 25, 2004

(54) Organic ionic conductive membrane for fuel cell and method for making same

(76) Inventor: Michel Pineri, Montbonnot (FR)

Correspondence Address: Burns Doane Swecker & Mathis, 1737 King Street # 400, Alexandria, VA, 22314-2727, US

(21) Appl. No.: 10/433,775

(22) PCT Filed: Dec. 6, 2001
(86) PCT No.: PCT/FR01/03856

(30) Foreign Application Priority Data
Dec. 8, 2000 (FR) 00 15983

(51) Int. Cl. H01M 8/10; C08J 5/22; H01M 10/40

(52) U.S. Cl. 429/33; 521/27; 429/314; 429/317

(57) ABSTRACT

The invention relates to an organic ionic conducting membrane for a fuel cell and to its process of manufacture.

This membrane comprises two surface layers (1, 3) made of proton conducting polymer, between which is positioned a porous layer (5) of proton conducting polymer, the pores of said porous layer containing a proton conducting material (7).

The proton conducting polymers of the two surface layers and of the porous layer can be identical or different sulphonated polyimides.

### TECHNICAL FIELD

The subject-matter of the present invention is organic ionic conducting membranes exhibiting a specific structure which renders them advantageous for use in fuel cells.

### STATE OF THE PRIOR ART

The interest of fuel cells now extends beyond that of power generators for space vehicles, and the automobile industry is taking an interest in them for at least two reasons:

the first is based on concern to avoid the pollution caused by internal combustion engines. This is because it is clear that all the improvements which may be expected by better control of combustion will have difficulty in avoiding any discharge of nitrogen oxide, of uncombusted hydrocarbons and of oxygenated compounds;

the second reason, for the longer term, is the search for engines which use a fuel other than fossil fuels, it being known that the latter will not last forever.

Any system based on hydrogen may meet the concerns mentioned above. The supply is potentially inexhaustible and electrochemical combustion produces only water.

A fuel cell, which makes possible both the production of electrical energy and secondarily the synthesis of water for the requirements of the crew of a spacecraft, comprises an ionic conducting membrane which is used to separate the anode compartment, where oxidation of the fuel, such as hydrogen H₂, takes place according to the scheme:

2H₂→4H⁺+4\overline{e};

from the cathode compartment, where the oxidizing agent, such as oxygen O₂, is reduced according to the scheme:

O₂+4H⁺+4\overline{e}→H₂O;

with production of water, while the anode and the cathode are connected by an external circuit.

The anode and the cathode are composed essentially of a porous support, for example made of carbon, on which particles of noble metal, such as platinum, are deposited.

The membrane and electrode combination is a very thin assembly with a thickness of the order of a millimetre and each electrode is fed via the rear with the gases using a fluted sheet.

A very important point is to properly maintain the membrane in a state of optimum humidity, in order to provide maximum conductivity.

The membrane has a twofold role. First, it has to make it possible to transfer hydrated protons H₃O⁺ from the anode to the cathode and, secondly, it has to keep each of the gases, oxygen and hydrogen, in its compartment.

The membrane is generally made of polymer and the latter has to meet a number of conditions relating to its mechanical, physicochemical and electrical properties.

The polymer must first of all be able to give thin films, of 50 to 100 micrometers, which are dense and free from defects. The mechanical properties, such as the tensile strength modulus and the extensibility, have to render it compatible with assembling operations comprising, for example, clamping between metal frames.

The properties have to be retained on passing from the dry state to the wet state.

The polymer must have a good thermal stability to hydrolysis and exhibit good resistance to reduction and to oxidation, at least up to 100° C. This stability is assessed in terms of variation in ionic resistance and in terms of variation in the mechanical properties.

Finally, the polymer must have a high ionic conductivity. This conductivity is introduced by strong acid groups, such as phosphoric acid groups but in particular sulphonic acid groups, connected to the chain of the polymer. For this reason, these polymers will generally be defined by their equivalent mass, that is to say by the weight of polymer in grams per acid equivalent.

By way of example, the best systems currently developed are capable of providing a specific power of 1 W.cm⁻², i.e. a current density of 4 A.cm⁻² for 0.5 volt.

Various ionic conducting membranes made of conducting polymer which are capable of being used in fuel cells are known. Thus, the document FR-A-2 748 485 [1] discloses sulphonated polyimides which can be used in the form of thin flat membranes in a fuel cell.

It is also possible to use, in fuel cells, composite organic membranes prepared by impregnation of porous structures, by a blend of polymers or by incorporation of inorganic compounds. Composite membranes with a porous structure made of polytetrafluoroethylene, the pores of which are partially filled with polymer-based electrolyte, such as membranes of GORE type, are disclosed, for example, in WO-A-98/11614 [2]. These membranes exhibit the disadvantage of requiring several impregnation-drying sequences to obtain a maximum degree of filling of the porous structures.

Ionic conducting membranes prepared from alloys are also known but these membranes have reduced conductivities, thus resulting in high ohmic drops when they are used in a cell.

### ACCOUNT OF THE INVENTION

A specific subject-matter of the present invention is an organic ionic conducting membrane which exhibits an advantageous structure, conferring on it better mechanical properties and properties of proton conductivity, while being more easily prepared than known composite membranes with porous structures.

According to the invention, the ionic conducting membrane comprises two surface layers made of proton conducting polymer, between which is positioned a porous layer of proton conducting polymer, the pores of said porous layer containing a proton conducting material.

In this membrane, the two surface layers are thin dense layers giving the character of impermeability to the gases, such as hydrogen and oxygen, used in a fuel cell. The porous layer of proton conducting polymer, which is thicker, confers mechanical properties on the assembly and furthermore improves the proton conductivity of the membrane by virtue of the presence of the proton conducting material present in the pores of the porous layer.

Preferably, this proton conducting material has a proton conductivity greater than those of the proton conducting polymers of the two surface layers and of the porous layer, so that the combined structure exhibits a greater proton conductivity.

The proton conducting polymers used in this conducting membrane can be any type of proton conducting organic polymer.

According to the invention, use is advantageously made, as proton conducting polymer for the surface layers and for the porous layer, of identical or different sulphonated polyimides.

Use may in particular be made of the sulphonated polyimides disclosed in FR-A-2 748 485 [1].

These sulphonated polyimides comprise repeat units of formula (Iₙ):

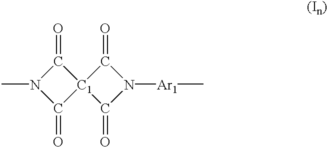

and repeat units of formula (Iₘ):

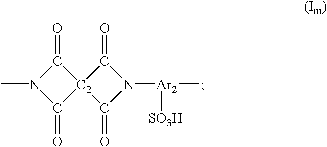

in which:

the groups C₁ and C₂ can be identical or different and each represent a tetravalent group comprising at least one optionally substituted carbonaceous aromatic ring having from 6 to 10 carbon atoms and/or one optionally substituted heterocycle with an aromatic nature having from 5 to 10 atoms and comprising one or more heteroatoms chosen from S, N and O; C₁ and C₂ each forming, with the neighbouring imide groups, rings comprising 5 or 6 atoms;

the groups Ar₁ and Ar₂ can be identical or different and each represent a divalent group comprising at least one optionally substituted carbonaceous aromatic ring having from 6 to 10 carbon atoms and/or one optionally substituted heterocycle with an aromatic nature having from 5 to 10 atoms and comprising one or more heteroatoms chosen from S, N and O; at least one of the said carbonaceous aromatic rings and/or heterocycles of Ar₂ additionally being substituted by at least one sulphonic acid group;

the repeat unit (Iₙ) being repeated j times and the (Iₘ) repeat unit being repeated k times, j and k being two integers.

Preferably, j represents an integer from 1 to 200, more preferably from 4 to 60, and k represents an integer from 1 to 300, preferably from 4 to 120.

These copolyimides can, according to the position of the two units of which they are composed, be defined as being block, alternating or random copolymers.

Polyimides exhibiting these characteristics can be prepared by condensation of dianhydrides with diamines by a two-stage synthesis, as is described in the reference [1].

Such a process is commonly employed industrially and requires only slight alterations to allow the preparation of the polyimides used in the invention.

The synthesis of a polyimide by condensation can be carried out by performing the following two stages.

In a first step, the condensation reaction of a dianhydride and of a diamine is carried out in order to obtain an intermediate polyamide-acid of formula (IV), referred to as “prepolymer”, according to the scheme below, given for the first type of repeat unit of the polyimides of the invention, i.e. the non-sulphonated unit:

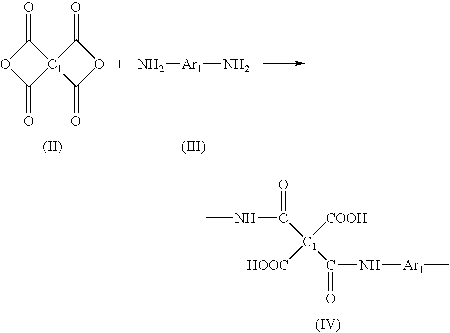

or according to the scheme below, for the second type of repeat unit of the polyimides according to the invention, i.e. the sulphonated unit:

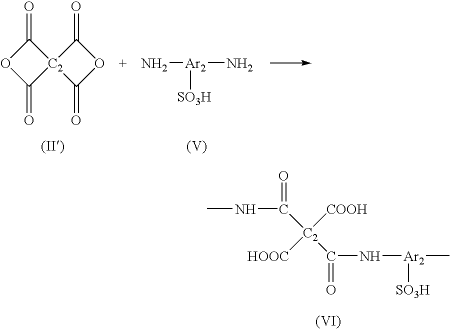

In a second step, the synthesis of the polyimide proper is carried out according to the following scheme, given by way of example for the first type of repeat unit;

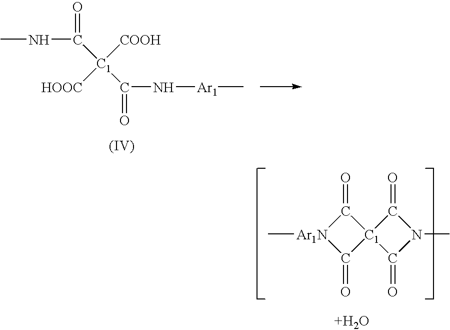

According to the invention, all the dianhydrides and all the diamines mentioned in FR-A-2 748 485 can be used for this synthesis.

According to an advantageous embodiment of the invention, the units of formula (Iₙ) of the sulphonated polyimides used are obtained by reaction of 1,4,5,8-naphthalenetetracarboxylic dianhydride (NTDA) of formula (VII):

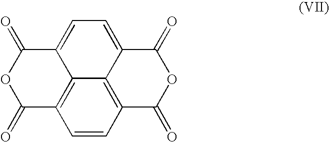

with a diamine chosen from the diamines of formulae (VIII), (IX) and (X):

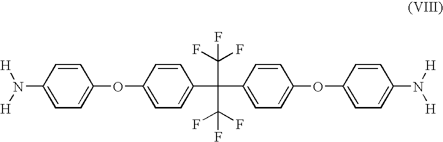

hereinafter referred to as BDAF,

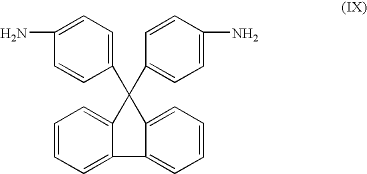

hereinafter referred to as CARDO,

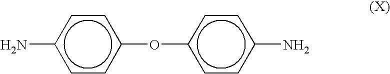

hereinafter referred to as ODA.

The units of formula Iₘ of the sulphonated polyimides used are obtained by reaction of 1,4,5,8-naphthalene-tetracarboxylic dianhydride (NTDA) of formula (VII) given above with 2,2′-diamino-4,4′-biphenyldisulphonic acid (BDSA) of formula (XI):

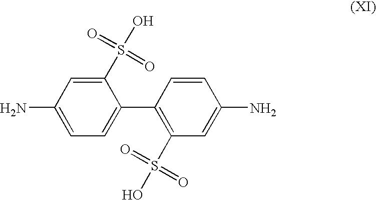

According to the invention, use may be made, as proton conducting material at least partially filling the pores of the porous layer, of any type of material providing good proton conduction. Generally, the proton conducting material present in the pores of the porous layer is composed of one or more components belonging to the group formed of functionalized oligomers and organic or inorganic acids.

The functionalized oligomers can be sulphonated oligomers obtained by condensation of an acid dianhydride, for example of formula (II) or (II′), such as NTDA, with a sulphonated diamine, for example of formula (XI), such as BDSA.

Mention may be made, as examples of organic and inorganic acids which can be used, of methanesulphonic acid, phosphoric acid, phosphoantimonic acid, and the like.

Generally, the structure of the membrane in accordance with the invention is such that the surface layers have a thickness of 1 to 10 μm and that the porous layer has a thickness of 10 to 200 μm.

Another subject-matter of the invention is a process for the manufacture of an ionic conducting membrane exhibiting the characteristics given above, which comprises the following steps:

1) preparing an asymmetric membrane comprising a surface layer made of proton conducting polymer and a porous layer made of proton conducting polymer,

2) incorporating the proton conducting material in the porous layer, and

3) forming the second surface layer made of proton conducting polymer on the porous layer containing the proton conducting material.

In the first step of this process, an asymmetric membrane is thus prepared comprising a dense surface layer made of proton conducting polymer and a macroporous layer which can be formed of the same conducting polymer or of a different conducting polymer.

This asymmetric membrane can be prepared by conventional processes, such as the immersion in a coagulation bath of a solution of conducting polymer, the sudden cooling of a solution of conducting polymer, or by pre-evaporating, for a short time, the polymer solution before immersing in the coagulation bath or cooling.

Techniques for producing asymmetric membranes are described in the following documents:

S. Loeb and S. Sourirajan, Advances in Chemistry Series, 38, 1963, p. 117-132 [3],

U.S. Pat. No. 4,247,498 [4], and

R. E. Kesting, Journal of Applied Polymer Science, vol. 17, 1973, p. 1771-1785 [5].

According to the invention, the asymmetric membrane made of proton conducting polymer can be prepared, for example, by starting from a solution in N-methyl-pyrrolidone (NMP) of a sulphonated polyimide in which the sulphonated blocks are obtained by reaction of BDSA with NTDA and the non-sulphonated blocks are obtained by reaction of BDAF or of CARDO with NTDA.

To obtain this membrane, a controlled evaporation of the solution is carried out in the presence of air, followed by immersing in water, which results in a dense layer with a thickness of a few micrometres and in an associated porous layer, with open porosity, having pores with a diameter of several micrometres.

With this technique, the relative thicknesses of the dense layer and of the porous layer and the dimensions of pores are controlled by varying the conditions for evaporating and immersing the initial solution.

The asymmetric membrane can also be prepared by successively casting two layers of different proton conducting polymers, one of the polymers being partially soluble in supercritical CO₂, and by subsequently exposing the combination to supercritical CO₂ to form the porous layer of the asymmetric membrane.

In this embodiment, one of the layers can be made of polyimide comprising sulphonated units obtained by reaction of BDSA and NTDA and non-sulphonated units obtained by reaction of ODA and NTDA, and the other layer can be made of polyimide comprising sulphonated units obtained by reaction of BDSA and NTDA and non-sulphonated units obtained by reaction of a fluorinated diamine, such as BDAF, with NTDA, this other layer being partially soluble in supercritical CO₂.

In fact, the layer comprising the fluorinated blocks of BDAF type exhibits a character of high solubility in supercritical CO₂ and the rapid evaporation of the CO₂ makes it possible to retain a significant porosity in this layer composed of a partially fluorinated polymer with a high glass transition temperature.

The second step of incorporation of the proton conducting material in the porous layer can be carried out either simultaneously during the preparation of the asymmetric membrane or after having prepared this asymmetric membrane.

The incorporation of the proton conducting material can be carried out simultaneously when the asymmetric membrane is prepared by immersing in a coagulation bath, by incorporating the proton conducting material in the coagulation bath so that it is trapped in the porous layer after evaporation of the solvent used in the coagulation bath.

The incorporation of the proton conducting material in the porous layer can also be carried out simultaneously by using a polymer composition comprising a proton conducting material composed of completely sulphonated oligomers. In this case, the completely sulphonated oligomers will have a tendency, during the immersing in the coagulation bath, to be ejected from the polymer phase and to be re-encountered in the pores.

In the case where incorporation of the proton material in the porous layer of the asymmetric membrane is carried out after the manufacture of the latter, this can be carried out by immersing the asymmetric membrane in a solution of the proton conducting material and evaporating the solvent from the solution.

The solvent used can be a polar solvent, such as water or an alcohol, as the wettability of the porous structure is promoted by these polar solvents, given that the porous structure exhibits sulphonic groups at the surface of its pores.

The third step of preparing the second surface layer made of proton conducting polymer on the porous structure, for the purpose of providing the ionic membrane with impermeability, can be carried out by bringing the asymmetric membrane obtained following the first and second stages into contact with a thin dense membrane in the course of preparation composed of a proton conducting polymer and of a solvent.

In order to obtain good adhesion of the second surface layer to the porous layer, the conducting polymer and the solvent of this second layer are chosen so that they are highly compatible with the polymer used in the porous layer in order to make possible interdiffusion of the two polymers, thus resulting in good adhesion.

It is possible, for example, to prepare an asymmetric membrane made of sulphonated polyimide comprising sulphonated units obtained by reaction of NTDA and BDSA and non-sulphonated units obtained by reaction of NTDA with ODA or BDAF and to apply, to this asymmetric membrane, a second dense layer obtained by evaporation of a solution of sulphonated polyimide comprising NTDA-BDSA sulphonated units and NTDA/ODA non-sulphonated units.

According to the invention, it is possible, furthermore, to add, to the dense layer applied in the third step, other ingredients used for preparing active layers of volume electrodes of fuel cells, for example catalysts deposited on graphite, hydrophobic polymers or proton conducting polymers.

Thus, with the invention, it is possible to obtain a good conducting interface between the membrane and the volume electrode in contact with this membrane.

Other characteristics and advantages of the invention will become more clearly apparent on reading the description which follows, given, of course, by way of illustration and without implied limitation, with reference to the appended drawing.

### BRIEF DESCRIPTION OF THE DRAWING

FIG. 1 gives a diagrammatic representation in vertical section of the structure of a conducting membrane in accordance with the invention.

### DETAILED ACCOUNT OF THE EMBODIMENTS

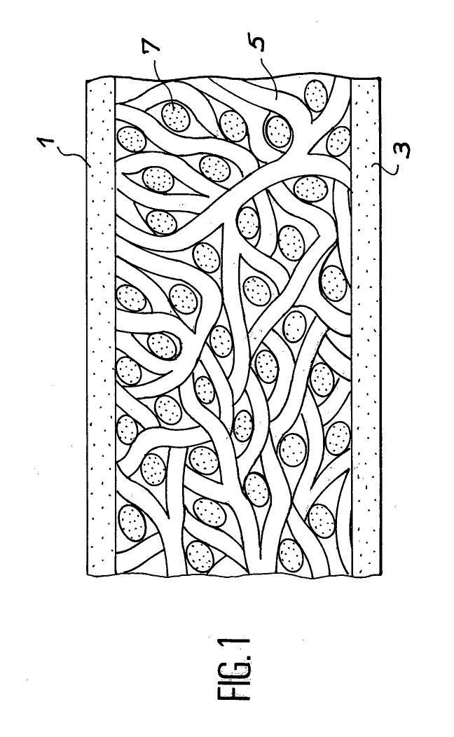

An ionic conducting membrane in accordance with the invention has been represented diagrammatically in vertical section in FIG. 1.

In this figure, it is seen that the conducting membrane comprises two dense surface layers 1 and 3 made of proton conducting polymer, between which is inserted a porous layer 5 made of proton conducting polymer which contains, inside these pores, an additional proton conducting material 7.

The layers 1 and 3 are thin but dense and free from defects; they contribute the character of impermeability to the gases, hydrogen and oxygen, used, for example, in a fuel cell.

An example of the preparation of a conducting membrane of this type is described below.

To prepare this membrane, use is made of two sulphonated naphthalene polyimides exhibiting a high glass transition temperature and a high thermal stability.

Preparation of the Sulphonated Polyimides

These polyimides are formed of hydrophilic and hydrophobic blocks respectively corresponding to the repeat units of formula (Iₘ) and (Iₙ). The hydrophilic block is the same for the two polyimides; only the hydrophobic block is different.

The hydrophilic blocks are obtained by polycondensation of the naphthalenic dianhydride (NTDA) of formula (VII) with the sulphonated diamine BDSA of formula (XI). A predetermined ratio of sulphonated diamine with respect to the NTDA is introduced in order to control the length of the ionic block. The molar ratio R₁ of the amounts of monomers during this first stage is defined by:

$${R}_{1} = \frac{n ( NTDA )}{n ( BDSA )}$$

where n=number of moles and (R₁<1).

In a step prior to the synthesis, it is necessary to convert the sulphonic acid functional groups of the sulphonated diamine (BDSA) to the triethylammonium salt. This is because the sulphonated diamine in the acid form is insoluble in the solvent for the synthesis.

A structure (XII) of naphthalene type is obtained:

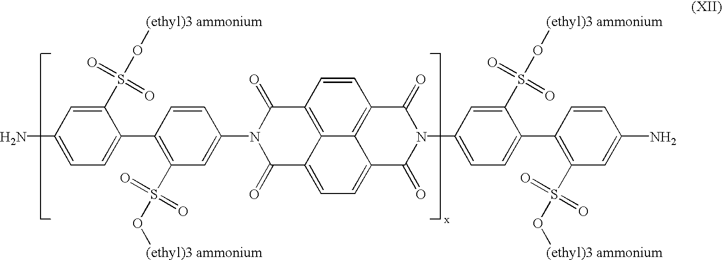

The hydrophobic blocks are obtained by polycondensation of the dianhydride (NTDA) of formula (VII) with the diamine of formula (VIII) or with the diamine of formula (IX).

In both cases, the number of moles of hydrophobic diamine of formula (VIII) or (IX) used is introduced in the ratio R₂ defined by:

$${R}_{2} = \frac{n ( BDSA )}{n ( diamine )}$$

with n (BDSA): the number of moles of BDSA introduced during the preparation of the hydrophilic blocks. This ratio defines the final ion exchange capacity (IEC in meq/g) of the polymer.

In order to complete the molar stoichiometry necessary for complete reaction with the hydrophobic diamine and with the sulphonated oligomer terminated by amine functional groups, a number of n_{stoichio} of dianhydride is added:

n_{stoichio}(dianhydride)=n(BDSA)+n(hydrophobic diamine)−n(dianhydride)

Two polyimides are thus obtained having the following naphthalene structures:

Sulphonated Polyimide 1:

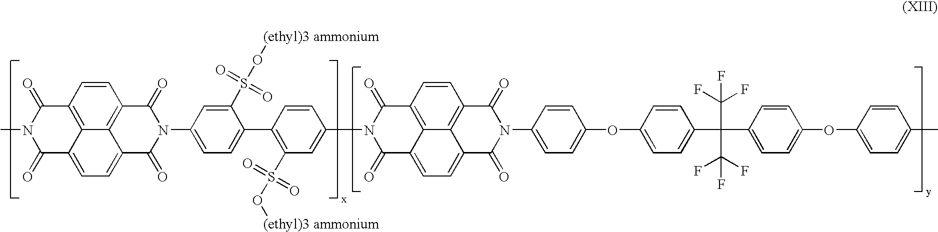

Sulphonated Polyimide 2:

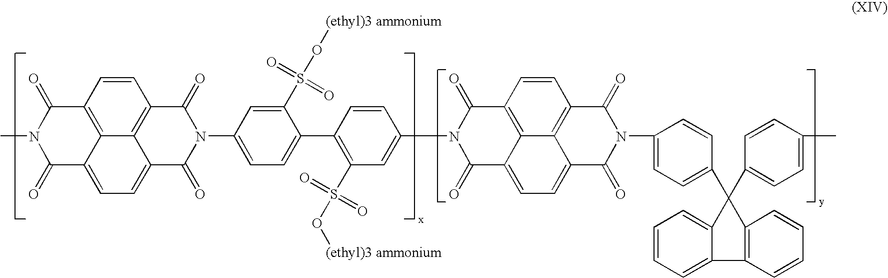

The dianhydride added reacts preferentially with the hydrophobic diamine to form hydrophobic blocks of a certain length. These hydrophobic blocks subsequently react with the ionic sites produced during the preparation of the hydrophilic blocks.

The size of the hydrophilic blocks (x) and hydrophobic blocks (y) is set by the ratios R₁ and R₂.

Preparation of the Ionic Conducting Membrane

To prepare this membrane, an asymmetric membrane is first of all prepared from a solution of the sulphonated polyimide 2 in N-methylpyrrolidone (NMP).

a) Preparation of the Asymmetric Membrane Charged with Conducting Material

This membrane is obtained from the solution of polyimide in NMP according to the phase inversion process. This technique consists in immersing the concentrated solution of the polyimide, also known as collodion, in a coagulation bath. The liquid of the bath is a non-solvent for the polymer, for example water, but is miscible with the solvent used in the polymer solution. During the immersion, rapid exchanges take place between the solution and the non-solvent medium. The opposite flows of solvent and of coagulant convert the homogeneous solution into a two-phase medium.

In order to prepare this asymmetric membrane, the collodion is applied to a matrix, for example to a glass sheet with dimensions of 18×18 cm, at ambient temperature, by means of a metal knife resting on several plastic supports positioned on each side of the glass sheet. The height of the supports with respect to the sheet directly determines the thickness of the membrane.

The matrix is then immersed in one litre of non-solvent (water) at ambient temperature. The coagulation bath is provided with mechanical stirring started before the immersion of the solution. This stirring drives away the exiting flow of solvent and thus makes possible better entry of the non-solvent. The time elapsing between the beginning of the spreading of the solution over the glass sheet and the introduction into the coagulation bath is set at one minute. During the immersion, the membrane detaches by itself from the glass sheet. It has two faces: one is glossy (active face) and corresponds to the surface brought directly into contact with the coagulant; the other is dull (porous substructure) and corresponds to the surface applied to the matrix.

The active face corresponds to the dense surface layer while the other layer corresponds to the porous layer.

In this implementational example, the proton conducting material was simultaneously introduced into the pores of the porous structure by adding, to the aqueous coagulation bath, oligomers of sulphonated polyimides corresponding to the hydrophilic blocks corresponding to the formula (XII). In that way, an asymmetric membrane is obtained comprising, in its porous layer, the proton conducting material.

b) Application of the Second Surface Layer

A dense layer made of sulphonated polyimide 1 or 2 is subsequently formed on the asymmetric membrane obtained. The deposition of this dense surface layer is obtained by bringing the asymmetric membrane obtained above into contact with a thin layer of solution of the sulphonated polyimide in NMP in the course of evaporation.

An ionic conducting membrane is thus obtained with a conductivity, in aqueous medium, of 10⁻¹ to 10⁻² S/cm.

### REFERENCES CITED

[1] FR-A-2 748 485

[2] WO-A-98/11614

[3] S. Loeb and S. Sourirajan, Advances in Chemistry Series, 38, 1963, p. 117-132

[4] U.S. Pat. No. 4,247,498

[5] R. E. Kesting, Journal of Applied Polymer Science, Vol. 17, 1973, p. 1771-1785

1. Ionic conducting membrane comprising two surface layers (1, 3) made of proton conducting polymer, between which is positioned a porous layer (5) of proton conducting polymer, the pores of said porous layer containing a proton conducting material (7).

2. Membrane according to claim 1, wherein the proton conducting material has a proton conductivity greater than those of the proton conducting polymers of the two surface layers and of the porous layer.

3. Conducting membrane according to either of claims 1 and 2, wherein the proton conducting polymers of the two surface layers and of the porous layer are identical or different sulphonated polyimides.

4. Membrane according to claim 3, wherein the sulphonated polyimides comprise repeat units of formula (Iₙ): 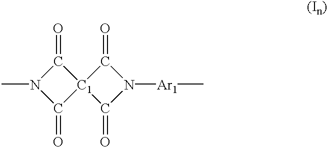
and repeat units of formula (Iₘ): 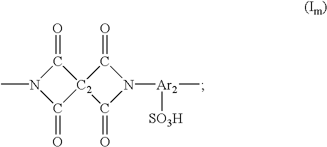
in which:
the groups C₁ and C₂ can be identical or different and each represent a tetravalent group comprising at least one optionally substituted carbonaceous aromatic ring having from 6 to 10 carbon atoms and/or one optionally substituted heterocycle with an aromatic nature having from 5 to 10 atoms and comprising one or more heteroatoms chosen from S, N and O; C₁ and C₂ each forming, with the neighbouring imide groups, rings comprising 5 or 6 atoms;
the groups Ar₁ and Ar₂ can be identical or different and each represent a divalent group comprising at least one optionally substituted carbonaceous aromatic ring having from 6 to 10 carbon atoms and/or one optionally substituted heterocycle with an aromatic nature having from 5 to 10 atoms and comprising one or more heteroatoms chosen from S, N and O; at least one of said carbonaceous aromatic rings and/or heterocycles of Ar₂ additionally being substituted by at least one sulphonic acid group;
the repeat unit (Iₙ) being repeated j times and the repeat unit (Iₘ) being repeated k times, j and k being two integers.

5. Membrane according to claim 4, wherein the sulphonated polyimides comprise units of formula Iₙ obtained by reaction of 1,4,5,8-naphthalenetetra-carboxylic dianhydride (NTDA) of formula (VII): 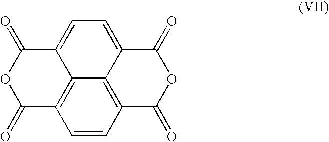
with a diamine chosen from the diamines of formulae: 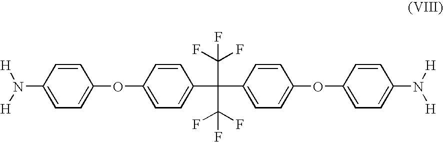
hereinafter referred to as BDAF, 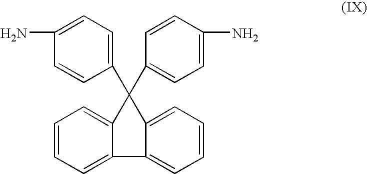
hereinafter referred to as CARDO, 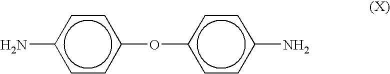
hereinafter referred to as ODA,
and units of formula Iₘ obtained by reaction of 1,4,5,8-naphthalenetetracarboxylic dianhydride (NTDA) of formula (VII) with 2,2′-diamino-4,4′-biphenyldisul-phonic acid (BDSA) of formula (XI):

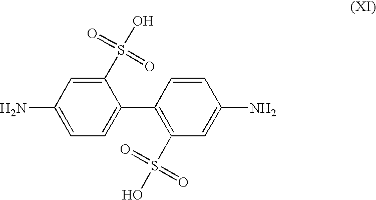

6. Membrane according to any one of claims 1 to 4, wherein the proton conducting material present in the pores of the porous layer is composed of one or more components belonging to the group consisting of functionalized oligomers and organic or inorganic acids.

7. Membrane according to claim 6, wherein the functionalized oligomers are sulphonated oligomers obtained by condensation of an acid dianhydride with a sulphonated diamine.

8. Membrane according to claim 7, wherein the dianhydride is 1,4,5,8-naphthalenetetracarboxylic dianhydride (NTDA) of formula (VII): 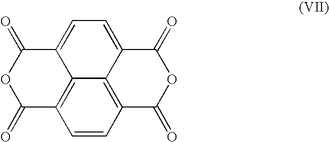
and the sulphonated diamine is 2,2′-diamino-4,4′-biphenyldisulphonic acid (BDSA) of formula (XI):

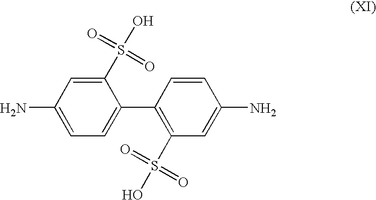

9. Membrane according to any one of claims 1 to 8, wherein the surface layers have a thickness of 1 to 10 μm and the porous layer has a thickness of 10 to 200 μm.

10. Process for the manufacture of an ionic conducting membrane according to any one of claims 1 to 9, wherein comprises the following steps:
1) preparing an asymmetric membrane comprising a surface layer made of proton conducting polymer and a porous layer made of proton conducting polymer,
2) incorporating the proton conducting material in the porous layer, and
3) forming the second surface layer made of proton conducting polymer on the porous layer containing the proton conducting material.

11. Process according to claim 10, wherein the asymmetric membrane is prepared by immersing in a coagulation bath a solution of proton conducting polymer.

12. Process according to claim 10, wherein the asymmetric membrane is prepared by sudden cooling of a solution of proton conducting polymer.

13. Process according to claim 10, wherein the asymmetric membrane is prepared by pre-evaporation, for a short time, of a solution of the proton conducting polymer, followed by immersing in a coagulation bath or by cooling.

14. Process according to claim 10, wherein the asymmetric membrane is prepared by successively casting two membranes made of different proton conducting polymers, one of the polymers being partially soluble in supercritical CO₂, and by subsequently exposing the combination to supercritical CO₂ to form the porous layer of the asymmetric membrane.

15. Process according to claim 14, wherein one of the membranes is made of polyimide comprising sulphonated units obtained by reaction of BDSA and NTDA and non-sulphonated units obtained by reaction of ODA and NTDA, and the other membrane is made of polyimide comprising sulphonated units obtained by reaction of BDSA and NTDA and non-sulphonated units obtained by reaction of BDAF and NTDA, this other membrane being partially soluble in supercritical CO₂.

16. Process according to claim 11, wherein the proton conducting material is incorporated in the porous layer by incorporating this material in the coagulation bath so that this material is trapped in the porous layer after evaporation of the solvent used in the coagulation bath.

17. Process according to claim 11, wherein the proton conducting material is incorporated in the porous layer, during the preparation of the asymmetric membrane, by using a polymer composition comprising a proton conducting material composed of completely sulphonated oligomers.

18. Process according to any one of claims 10 to 15, wherein the proton material is incorporated in the porous layer by immersing the asymmetric membrane in a solution of the proton conducting material and evaporating the solvent from the solution.
